(19) United States
(12) Patent Application Publication
(10) Pub. No.: US 2025/0065494 A1
(43) Pub. Date: Feb. 27, 2025

(54) SYSTEM FOR TEACHING A ROBOTIC ARM

(71) Applicant: KINOVA INC., Boisbriand (CA)

(72) Inventors: Mathieux BERGERON, Saint-Joseph-du-Lac (CA); André DUBREUIL, Boisbriand (CA); Mathiew MOINEAU-DIONNE, Mirabel (CA); Jean-Michel AUDET, Boisbriand (CA); Simon FERRON-FORGET, Deux-Montagnes (CA); Vitaliy KHOMKO, Boisbriand (CA)

(21) Appl. No.: 18/724,437

(22) PCT Filed: Jan. 20, 2023
(86) PCT No.: PCT/CA2023/050063

§ 371 Date: Jun. 26, 2024

Related U.S. Application Data
(60) Provisional application No. 63/301,756, filed on Jan. 21, 2022.

(51) Int. Cl. B25J 9/16; G05B 19/425

(52) U.S. Cl. CPC B25J 9/161; B25J 9/163; G05B 19/425; G05B 2219/36417

(57) ABSTRACT

A programming interface of a robotic arm may have a programming table including rows and columns of cells, wherein the cells in the rows or in the columns represent an execution sequence. Tiles may be positionable in the cells, each of the tiles representing at least one of an action, a decision, a condition associated with the robotic arm. During operation of the robotic arm, a controller operates the robotic arm based on the execution sequence and on the tiles in the programming table.

### CROSS-REFERENCE TO RELATED APPLICATION

The present application claims the priority of U.S. Patent Application No. 63/301,756, filed on Jan. 21, 2022, the contents of which are incorporated herein by reference.

### TECHNICAL FIELD

The present application relates to robotic arms and to operating systems associated with robotic arms to teach or program maneuvers to a robotic arm.

### BACKGROUND OF THE ART

Robotic arms are increasingly used in a number of different applications, from manufacturing, to servicing, and assistive robotics, among numerous possibilities. Such robots can be used to perform given tasks, including repetitive tasks. The tasks may be in the form of given movements, effector operations and maneuvers. These given movements may include moving an end effector to selected waypoints, along desired movement paths, applying forces of determined magnitude. The given tasks may include operating an end effector in certain ways depending on the type of end effector, etc.

Accordingly, a robotic arm must be taught, i.e., programmed, to execute given movements and perform given tasks. The level of complexity may vary in how the robotic arm is taught, and the teaching may often include a programming interface and a controller. However, the programming of a robotic arm may suffer from some inefficiencies, notably by the need for an operator to alternate maneuvers between a robotic arm and a programming interface (also known as a teach pendant), especially in the context of a collaborative mode in which the operator may manipulate the robotic arm during programming.

### SUMMARY

It is an aim of the present disclosure to provide a visual programming interface that addressed issues related to the art.

It is a further aim of the present disclosure to provide a robot teaching system that addressed issues related to the art.

Therefore, in accordance with a first aspect of the present disclosure, there is provided a programming interface of a robotic arm comprising: a programming table including rows and columns of cells, wherein the cells in the rows or in the columns represent an execution sequence; tiles positionable in the cells, each of the tiles representing at least one of an action, a decision, a condition associated with the robotic arm; wherein, during operation of the robotic arm, a controller operates the robotic arm based on the execution sequence and on the tiles in the programming table.

Further in accordance with the first aspect, for instance, the cells in the rows represent the execution sequence.

Still further in accordance with the first aspect, for instance, the cells in a common one of the columns represent a condition sequence.

Still further in accordance with the first aspect, for instance, tiles in the cells in the common one of the columns forming the condition sequence are each adjacent to another tile in a respective one of the rows, the other one of the tiles indicating an action and/or a decision of the condition sequence.

Still further in accordance with the first aspect, for instance, at least one of the tiles is a waypoint tile identifying at least one waypoint position and/or orientation to which the controller directs the robotic arm.

Still further in accordance with the first aspect, for instance, the waypoint tile further includes at least one parameter setting associated with a movement of the robotic arm to the waypoint position and/or orientation.

Still further in accordance with the first aspect, for instance, the at least one waypoint position and/or orientation of the waypoint tile is set from a signal received from a wrist of the robotic arm.

Still further in accordance with the first aspect, for instance, at least one of the tiles is a script tile, according to which the controller operates the robotic arm as a function of the script.

Still further in accordance with the first aspect, for instance, the script is Python®.

Still further in accordance with the first aspect, for instance, the script is imported into a field of the programming interface.

Still further in accordance with the first aspect, for instance, at least one of the tiles is associated with an actuation of an end effector of the robotic arm.

Still further in accordance with the first aspect, for instance, the end effector is a gripper.

Still further in accordance with the first aspect, for instance, the at least one tile associated with the actuation is to cause an opening of the gripper.

Still further in accordance with the first aspect, for instance, the at least one tile associated with the actuation is to cause a closing of the gripper.

Still further in accordance with the first aspect, for instance, the at least one tile associated with the actuation further includes at least one parameter setting associated with the actuation of the gripper.

Still further in accordance with the first aspect, for instance, the at least one parameter setting associated with the actuation of the gripper is a closing force or a closing speed.

Still further in accordance with the first aspect, for instance, the at least one tile associated with the actuation is to cause the end effector to seek the presence of an object by contact.

Still further in accordance with the first aspect, for instance, the at least one tile associated with the actuation further includes at least one parameter setting associated with the seek of the object, wherein the at least one parameter setting associated with the seek is one or more of a limit of contact force, a limit of displacement speed, a constraint in trajectory of movement.

Still further in accordance with the first aspect, for instance, at least one of the tiles is associated with an operation of a vision system of the robotic arm.

Still further in accordance with the first aspect, for instance, the operation of the vision system includes providing a video feed on the programming interface.

In accordance with a second aspect of the present disclosure, there is provided system for teaching a robotic arm comprising: a user interface at a working end of a robotic arm; a processing unit; and a non-transitory computer-readable memory communicatively coupled to the processing unit and comprising computer-readable program instructions executable by the processing unit for: recording a position of the working end of the robotic arm in response to signaling from the user interface in a first mode; recording an orientation of the working end of the robotic arm in response to signaling from the user interface in a second mode; and toggling between at least the first mode and the second mode in response to signaling from the user interface.

Further in accordance with the second aspect, for instance, in the first mode, the robotic arm moves in Cartesian admittance as a response to a force applied to the working end, the working end having a constant orientation in the Cartesian admittance.

Still further in accordance with the second aspect, for instance, in the second mode, the robotic arm moves in angular admittance as a response to a force applied to the working end, the robotic arm constraining movement to a rotation of a single joint in the angular admittance.

Still further in accordance with the second aspect, for instance, recording a force applied at the working end of the robotic arm may be in response to signaling from the user interface in a third mode.

### DESCRIPTION OF THE DRAWINGS

FIG. 1 is a perspective view of an exemplary articulated robotic arm used with the system for teaching of the present disclosure;

FIG. 2 is a perspective view of a wrist of the exemplary articulated robotic arm of FIG. 1, showing an interface;

FIG. 3 is another perspective view of the wrist of FIG. 2, illustrating connectors; FIG. 4 is a face view of the interface of the wrist;

FIG. 5 is a block diagram of a system for teaching the robotic arm in accordance with the present disclosure;

FIG. 6 is a screen view of functionalities associated with hand guiding of the robotic arm;

FIG. 7 is a screen view of an angular control of a jog functionality for adjustment of joint angles;

FIG. 8 is a screen view of the angular control of the jog functionality for adjustment of joint angular speed;

FIG. 9 is a screen view of a Cartesian control of the jog functionality for adjustment of end effector position and orientation;

FIG. 10 is a screen view of the Cartesian control of the jog functionality for adjustment of end effector velocity and angular speed

FIG. 11 is a screen view of an exemplary GUI with a programming table in accordance with an aspect of the present disclosure;

FIG. 12 is a screen view of the programming table of FIG. 11;

FIG. 13 is a screen view showing an example of a sequence of programmed actions in a loop in the programming table of FIG. 11;

FIG. 14 is a screen view showing an example of a sequence of programmed actions in a condition program in the programming table of FIG. 11;

FIG. 15 is a screen view showing an example of a sequence of programmed actions for a generic gripper using the programming table of FIG. 11;

FIG. 16 is a screen view showing an example of a waypoint recording screen, in Cartesian mode;

FIG. 17 is a screen view showing an example of a waypoint recording screen, in angular mode;

FIG. 18 is a screen view showing an example of a matrix function for the programming table of FIG. 11;

FIG. 19 is a screen view showing a parametrization screen of the matrix function for the programming table of FIG. 11;

FIG. 20 is a screen view showing an example of a safety parameter setting page associated with the system of FIG. 5;

FIG. 21 is a screen view showing an example of another safety parameter setting page associated with the system of FIG. 5;

FIG. 22 is a screen view showing an example of a video feed relative to other zones when a vision system is used as a peripheral;

FIG. 23 is a block diagram showing a non-blocking function associated with the programming table of FIG. 11

FIG. 24 is a screen view showing an example of a plugin screen;

FIG. 25 is a screen view showing an example of a seek function screen;

FIG. 26 is a screen view showing an example of a variable data screen; and

FIG. 27 is a screen view showing an example of a script entering screen.

### DETAILED DESCRIPTION

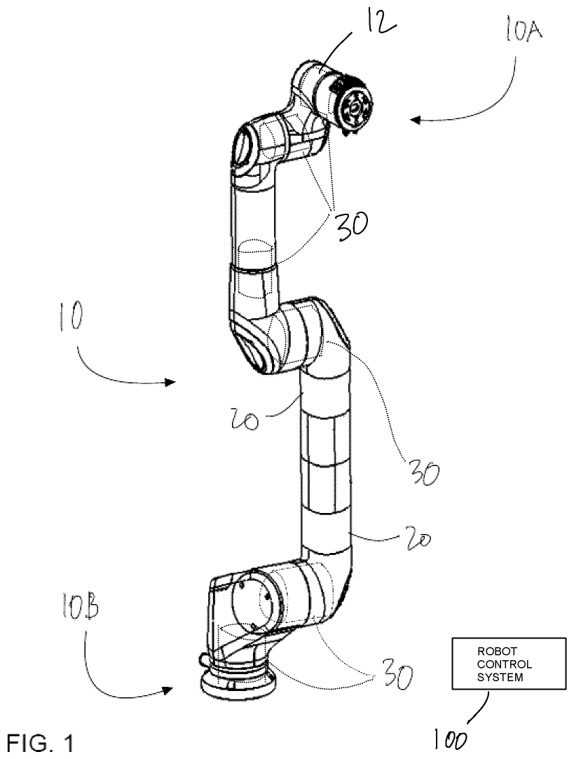

Referring to the drawings and more particularly to FIG. 1, a mechanism such as a robot arm in accordance with the present disclosure is generally shown at 10, and is also referred to as an articulated robotic arm or robotic arm, etc. Although a system for teaching a robot described herein is shown on the robotic arm 10, it may be used with other mechanisms, such as articulated mechanisms or arms, serial mechanisms or arms, parallel mechanisms or arms, or like mechanisms or arms. However, for simplicity, the expression “robot arm” is used throughout, but in a non-limiting manner. The robotic arm 10 is a serial articulated robot arm, having a working end 10A, i.e., the end at which an end effector is connected, and a base end 10B. The working end 10A is configured to receive any appropriate tool, such as gripping mechanism or gripper, anthropomorphic hand, tooling heads such as screwdrivers, drills, saws, an instrument drive mechanism, camera, etc. The end effector secured to the working end 10A is as a function of the contemplated use.

The base end 10B is configured to be connected to any appropriate structure or mechanism. The base end 10B may be rotatably mounted or not to the structure or mechanism. By way of a non-exhaustive example, the base end 10B may be mounted to a wheelchair, to a vehicle, to a frame, to a cart, to a robot docking station. Although a serial robot arm is shown, the joint arrangement of the robotic arm 10 may be found in other types of robots, including parallel manipulators.

Still referring to FIG. 1, a wrist 12 is shown at the working end 10A of the robotic arm 10. The wrist 12 is one of a series of links of the robotic arm 10. The wrist 12 may be referred to as a wrist link, a distal link, etc, and may even be referred to as end effector. The wrist 12 may be connected to a remainder of the robotic arm 10 by a motorized joint unit as described below.

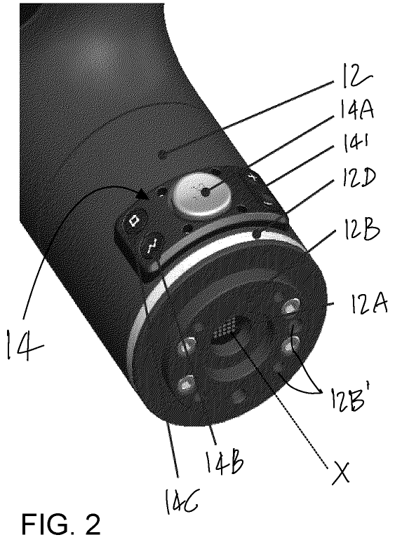

Referring concurrently to FIGS. 2 to 4, the wrist 12 may have numerous exposed components to allow connection of an end effector, and to enable a user to communicate with a control system associated with the robotic arm 10. In an embodiment, the wrist 12 rotates about axis X, and may be movable in numerous degrees of freedom enabled by the robotic arm 10.

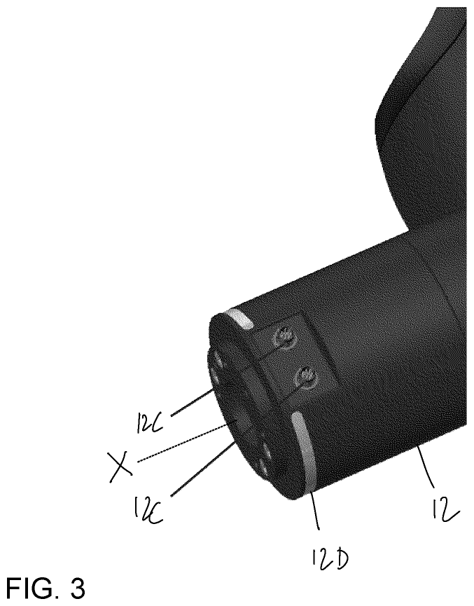

Among possible components present at the wrist 12, a connector 12A may be provided. The connector 12A may be a pogo-pin type socket by which a tool may be connected to a control system of the robotic arm 10. Other types of sockets, plugs, connectors may be used, the pogo-pin type socket being merely provided as an example. For instance, the connector 12A provides Ethernet connection, that may comply with the RS-485 standard or other standards, and/or may have any appropriate power output (e.g., 24V, 4A). A flange 12B or like raised support (shown as an annular support surface) may surround the connector 12A may be provided with attachment bores 12B′ or other female or male attachments. Threading may be provided in the attachment bores 12B′. An end effector, tool, peripheral with complementary attachments could hence be fixed to the wrist 12, the end effector, tool, peripheral also having a complementary connector for electronic engagement with the connector 12A. Referring to FIG. 3, additional connectors may be provided, such as peripheral connectors shown as 12C. As exemplary connectors 12C, M8 8-pin connectors are shown. Other types of connectors may be present (e.g., various USBs, etc.)

A light display 12D may be provided. In an embodiment, the light display 12D extends peripherally around the wrist 12, to provide visibility from an enhanced point of view. For example, the light display 12D may cover at least 180 degrees of the circumference of the wrist 12. In the illustrated embodiment, the light display covers between 280 and 320 degrees of the circumference of the wrist 12. The light display 12D may be considered a user interface as it may provide information to the operator, such as a flashing or color indication when certain teaching tasks are performed. The light display 12D may take other forms or configurations. For example, discrete lights may be present in addition to or as alternatives to the light display 12D. In an embodiment, the various lights are light-emitting diodes (LEDs), though other types of light sources may be used. The LEDs, such as those in the light display 12D, may be RGD LEDs.

An interface 14 may also be present on the wrist 12, and may include buttons, an additional port, etc. An exemplary combination of buttons for the interface 14 are provided, but any other arrangement than that shown and described is possible. The interface 14 may include an enabling button(s) 14A to enable a manual control of directional movements of the wrist 12. By pressing on the enabling button 14A, a user may manipulate the robotic arm 10. Accordingly, the pressing of the enabling button 14A may cause a release of all brakes or of selected brakes at the various joints of the robotic arm 10, such that the user may displace the end effector at the end of the wrist 12 and/or move the links at opposite sides of any of the joints. In a variant, the user may be required to maintain a pressure on the enabling button 14A for the manual control to be activated, i.e., to allow a freedom of movement. Moreover, an excessive pressure on the enabling button 14A may result in a braking of the robotic arm 10, as an option. Practically speaking, the user may use one hand to press on the enabling button 14A, and the other hand may be free to manipulate other parts of the robotic arm 10, to press on other buttons to record a condition of the robotic arm 10, and/or to use an interface associated with a controller of the robotic arm 10. The enabling button 14A may also be used as an on/off switch for the manual control mode, whereby a single press on the enabling button 14A may allow a user to toggle between an activation and deactivation of the manual control mode. Alternatively, the enabling button 14A could also have a sensitive periphery, with the robotic arm 10 responding to a press of the enabling button 14A to move in the pressed direction.

Other buttons may be present, such as single-function buttons 14B and 14C. For example, button 14B may be a position capture button (a.k.a., waypoint capture button), whereas button 14C may be a mode toggling button, as will be explained below. There may be fewer or more of the single-function buttons 14B and 14C, and such buttons may be associated with any given function. A 2-position level button 14D may be present, to select (e.g., increase or decrease) a level of intensity, as observed from the +/− symbols. The 2-position level button 14D may be known as a volume button. The buttons 14A, 14B and 14C are shown as being mechanical buttons, in that a mechanical force must be applied to trigger electronic components. However, some other arrangements are possible, for instance by having only the enabling button 14A be a mechanical button, or by having all buttons being capacitive, resistive or like touch-sensitive buttons. In an embodiment, the button 14A differs in shape from the buttons 14B, 14C, and from the button 14D, to provide a user with a visual distinction between buttons and hence make the use of the interface 14 more intuitive. In an embodiment, the interface 14 may comply with the standard ANSI/UL 508, as the interface 14 operating the robot arm 10 is an industrial control device, for starting, stopping, regulating, controlling, or protecting electric motors, described below for example as being part of the motorization units 30.

Other types of wrist interfaces are contemplated. For example, a touchscreen may be used instead of the mechanical buttons, to provide similar functions, or additional ones, and provide display capacity as well. The touchscreen could thus be used as an alternative to both the light display 12D and to the buttons 14A-14C.

In addition to the wrist 12 at its working end 10A, the robotic arm 10 has a series of links 20, interconnected by motorized joint units 30, at the junction between adjacent links 20, forming joints between the links 20, the joints being for example rotational joints (a.k.a., one rotational degree-of-freedom (DOF) joints). The motorized joint units 30 may integrate brakes. For example, the integrated brakes may be normally open brakes that block the robotic arm 10 from moving when the robotic arm 10 is not powered. The brakes in the motorized joint units, or at least some of the brakes in the motorized joint units 30, may be normally open brakes. The brakes integrated in the motorized joint units 30 may be for example as described in U.S. Pat. No. 10,576,644, incorporated herein as reference, but other types of brakes may be used. A bottom one of the links 20 is shown and referred to herein as a robot arm base link 20′, or simply base link 20′, and may or may not be releasably connected to a docking cradle. For instance, the base link 20′ may be as described in United States Patent Application Publication No. US2020/0086504, incorporated herein by reference.

The links 20, including the wrist 12, define the majority of the outer surface of the robotic arm 10. The links 20 also have a structural function in that they form the skeleton of the robotic arm 10 (i.e., an outer shell skeleton), by supporting the motorized joint units 30 and tools at the working end 10A, with loads supported by the tools, in addition to supporting the weight of the robotic arm 10 itself. Electronic components may be concealed into the links 20. The arrangement of links 12, 20 provides the various degrees of freedom (DOF) of movement of the working end 10A of the robotic arm 10. In an embodiment, there are sufficient links 12, 20 to enable six DOFs of movement (i.e., three rotations and three translations) to the working end 10A, relative to the base link 20′. There may be fewer or more DOFs depending on the use of the robotic arm 10.

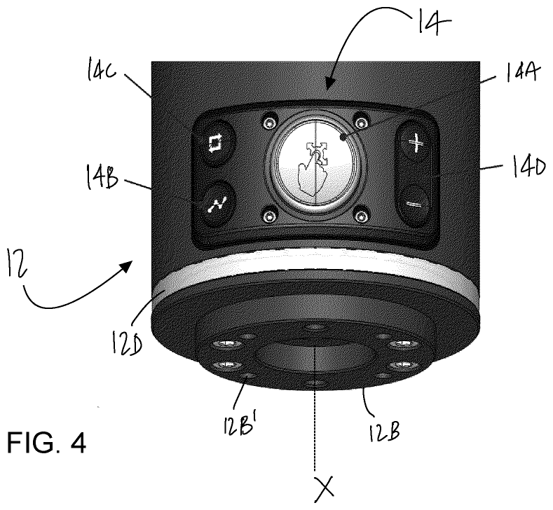

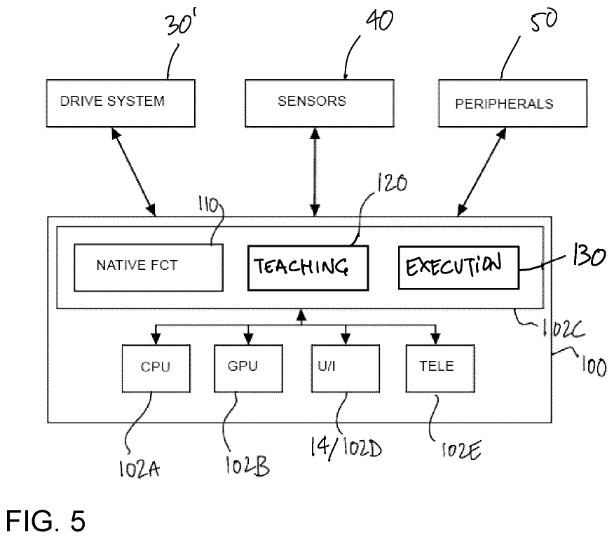

The motorized joint units 30 interconnect adjacent links 20, in such a way that a rotational degree of actuation is provided between adjacent links 20. According to an embodiment, the motorized joint units 30 may also connect a link to a tool via the wrist 12 at the working end 10A, although other mechanisms may be used at the working end 10A and at the base end 10B. The wrist 12 may be straight in shape, in contrast to some other ones of the links 20 being elbow shaped. The motorized joint units 30 may also form part of a structure of the robotic arm 10, as they interconnect adjacent links 20. The motorized joint units 30 form a drive system 30′ (FIG. 5) of the robotic arm 10 as they are tasked with driving the end effector connected to the robotic arm 10, for instance in accordance with a robotic application or commands, or through user commands. While they are schematically shown, the motorized joint units 30 may include motors, gearboxes, brake(s), drive electronics, among other things, to actuate movements of the robotic arm 10.

A communications link may extend through the robotic arm 10. In an embodiment, each link 20 includes signal transmission means (e.g., wires, cables, PCB, plugs and sockets, slip rings, etc), with the signal transmission means being serially connected from the base end 10B to the working end 10A, such that an end effector and a base controller may be communicatively coupled. The communications link may also be via a wireless communications link. The communications link may be accessible via the connector 12A, and the connectors 12C.

Numerous sensors 40 (FIG. 5) may be provided in the robotic arm 10, to automate a control of the robotic arm 10. The sensors 40 may include one or more of encoders, optical sensors, inertial sensors, force/torque sensors, infrared sensors, thermocouples, pressure sensors, proximity switches, etc. Moreover, additional peripheral(s) 50 may be mounted to the robotic arm 10.

In an embodiment, the peripheral 50 may be associated with third party applications, as described below, and may use the available plug 10A′, for instance to be connected to the working end 10A of the robotic arm 10 if desired. Exemplary peripherals are an end effector (e.g., gripper), camera(s), a sensor(s), a light source(s). The peripheral(s) 50 may be the end effector as a standalone device, or may be used as a complement to the end effector, or may be part of a group of tools/instruments forming the end effector at the working end 10A of the robotic arm 10.

Referring concurrently to FIGS. 1 and 5, a robot control system in accordance with the present disclosure is generally shown at 100. The robot control system 100 may be integrated into the robotic arm 10, such as in the base link 20′, in a docking station, in any other link, or as a separate unit, for instance in its casing. The robot control system 100 may include a processing unit. The processing unit may include all necessary components to operate the robotic arm 10, such as a central processing unit (CPU) 102A, graphics processing unit (GPU) 102B, a non-transitory computer-readable memory 102C, that may contain computer-readable program instructions executable by the processing unit for performing given functions associated with the robotic arm 10, including performing teaching tasks. The CPU 102A may include an operating system of the robotic arm 10, with or without using the non-transitory computer-readable memory 102C.

In addition to the interface 10A″ at the working end 10A of the robotic arm 10, additional interface or interfaces 102D may be part of the robot control system 100, or may be a peripheral of the robot control system 100, for a user to communicate with and receive data from the robot control system 100. The interface(s) 102D may be embedded or integrated in the robotic arm 10, or may be physically separated from the robotic arm 10. The interface(s) 102D may take numerous forms, such as a screen or monitor, a graphic user interface (GUI), a touch screen, visual indicators (e.g., LED), tablet, an application on a smart device (e.g., phone, tablet), keyboard, mouse, push buttons, etc. One of the interface(s) 102D may be used for controlling the robotic arm 10, and for teaching the robotic arm 10. Such a user interface 102D may be referred to as a teach pendant, a teach box, a remote controller, among other possible names. In an embodiment, the user interface 102D used as teach pendant may be wireless and may communicate with a remainder of the robot control system 100 of the robotic arm 10.

The robot control system 100 may further include telecommunications module 102E by which the robot control system 100 may communicate with external devices, systems. The telecommunications module 102E may have wireless and/or wired capability.

For example, the computer-readable program instructions may include native functions 110 of the robotic arm 10. The native functions 110 may include one or more of controllably moving the working end 10A in the available degrees of freedom of the robotic arm 10; holding a fixed position; performing a safety braking maneuver; permitting hand guiding and teaching; measuring the interaction forces on the robotic arm 10, among other native functions. The native functions 110 may be connected to the drive system 30′ for the control system 100 to drive the robotic arm 10 in a desired manner. The native functions 110 may also operate based on feedback provided by the sensors 40 within or associated to the robotic arm 10. The sensors 40 contribute to the high precision control of the robotic arm 10 in its working envelope.

Still referring to FIG. 5, the computer-readable program instructions of the robot control system 100 may further include a teaching module 120, used for example with an execution module 130. The teaching module 120 is used to teach (a.k.a., program or train) the robotic arm 10 in performing movements and/or tasks, and the execution module 130 may record the teaching and subsequently performs the movements and tasks as taught. The tasks may be in the form of given movements, effector operations and maneuvers. These given movements may include moving an end effector to selected waypoints, along desired movement paths, applying forces of determined magnitude. The given tasks may include operating an end effector in certain ways depending on the type of end effector, etc. The teaching module 120 and the execution module 130 may be run with the operating system of the robot control system 100, and may have access to the various resources of the robot control system 100, such as CPU 102A, GPU 102B, interface(s) 14 and 102D, telecommunications module 102E, sensor data, native functions 110.

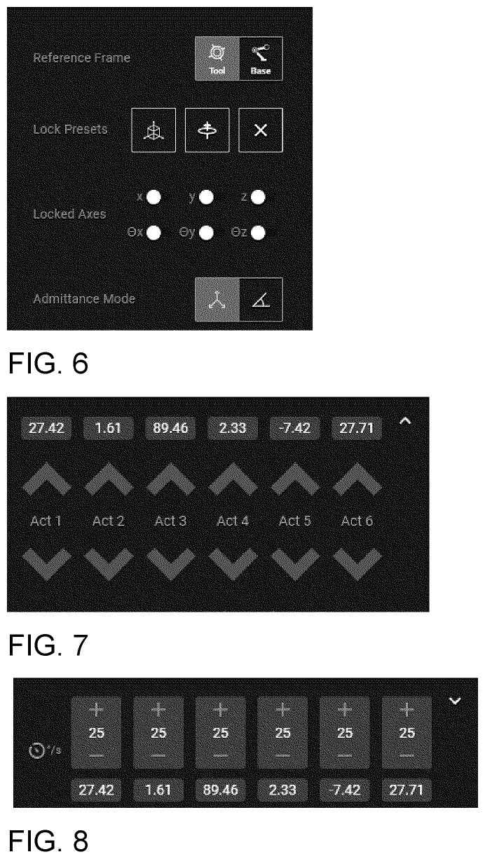

Referring to FIG. 6, as part of the native functions 110, the user may hand guide the robotic arm 10. FIG. 6 shows an exemplary screen that may be displayed on interface(s) 14 and/or 102D, during hand guiding. As part of the hand guiding, the user may be assisted by the robot control system 100 in moving the end effector, for example by blocking one or more translations along given axes (e.g., X, Y, Z), or by blocking one or more rotations along given axes. The referential systems of locking can be on the base or on the end effector. Hence, the Locked Presets in FIG. 6 enables such blocking, and the Locked Axes indicate which axes are locked. If the user wishes to apply forces on any one of the links 20 to cause its rotation, or on the end effector, the Admittance Mode button may be activated to allow one or the other hand guiding approaches (other names being possible for this function). The user may have the possibility of selecting a frame of reference for locking the axes, such a X-Y-Z/phi, theta, rho coordinate system. In a variant, the hand guiding may be operated in different modes, such as a Cartesian admittance mode, and a Joint admittance mode. These modes may be activated using the enabling button 14A, such as by maintaining a pressure on the button 14A as a possibility (other options being possible). In the Cartesian admittance mode, the robot control system 100 responds to external forces on the working end 10A by activating selected motorization joint units 30 to cause of a displacement of the working end 10A aligned with the external forces, for the working end 10A to have a new position, for example while preserving the orientation of the working end 10A. In doing so, the robot control system 100 monitors the relation between links to avoid singularities. The movement may be constrained if given axes are locked. For example, the working end 10A may be limited to movement along the X axis. In the Joint admittance mode, the external forces applied to the working end 10A are converted to rotation of one or more motorized joint units 30, without preserving an orientation of the working end 10A. Toggling button 14C may be used to change between admittance modes.

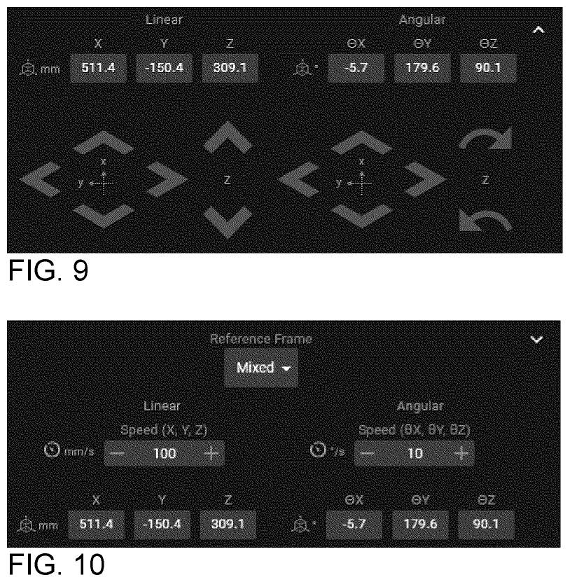

Referring to FIGS. 7-10, still as part of the native functions 110, the user may perform a jog function of the robotic arm 10, i.e., numerically control movements of the end effector or links 20, in angular control, or in Cartesian control. In FIG. 7, in angular control, an angle of orientation of one or more of the joints may be adjusted (i.e., the relative rotation between links 20 on opposite sides of a motorized joint unit 30), with directional interface arrows, and with the current angle values being shown, optionally. For example, six different columns are shown in FIG. 7, indicating six different joints 30 to be controlled. Other arrangements are possible. In FIG. 8, again in angular control, an angular speed may also be set, with +/− interface signs. The speed may be displayed in degrees/second, for example, and may be the maximum angular speed, along with the current angle values optionally displayed. In both instances, the buttons on the wrist 12 may be used to modify the values, for example using the volume button 14D, and buttons 14B and 14C to change field or mode. In FIG. 9, in Cartesian control, a position of the end effector may be adjusted with directional interface arrows in all available degrees of freedom (e.g., three translations), with the current X, Y, Z values being displayed, optionally. The orientation of the end effector may also be adjusted, with directional interface arrows, and with the current angle values being shown, for example relative to the three axes of the reference frame. In FIG. 10, again in Cartesian control, a velocity and/or an angular speed may also be set, with +/− interface signs. The velocity and/or speed may be displayed in mm/second (or like distance per time unit) and degrees/second, for example. It may also be possible for a user to select a specific distance of movement, e.g., along a given direction, as an alternative to setting velocity values. Optionally, the reference frame used for these controls may be selected. For example, the X, Y, Z referential system could be for the base link 20′ or ground. Alternatively, the X, Y, Z referential system could be on the working end 10A. The user may toggle between such reference frames. For example, if the working end 10A has its end effector in a desired orientation, it may be preferred to use the reference frame of the working end 10A to teach trajectories that preserve the orientation, such as by limiting movement of the end effector to a single axis, such as the Z-axis of the working end 10A. This may simplify the teaching.

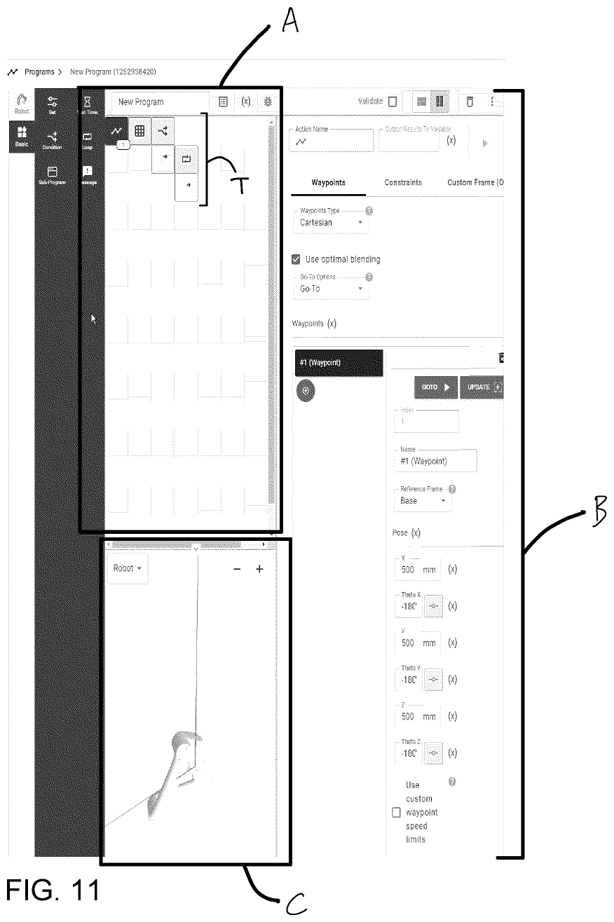

Referring to FIG. 11, an exemplary graphic user interface (GUI) used by the teaching module 120 is shown. The GUI of FIG. 11 may also be used by the execution module 130 to provide an operator with operational data during use of the robotic arm 10. As observed from FIG. 11, the GUI may include a programming table A, a parameter zone B, and/or a viewing zone C. The programming table A is used to program the robotic arm 10 with sets of actions, represented by tiles T. The parameter zone B displays data associated with the actions of the tiles T. The viewing zone C is optionally present to provide images, such as the illustrated schematic or virtual representation of the robotic arm 10, for instance in its current arrangement, or in an arrangement derived from an action and tile T. The viewing zone C could also provide camera images. In a variant, the programming table A may be programmed by a drag and drop option, with the user having access to tiles T indicative of some actions, as described below.

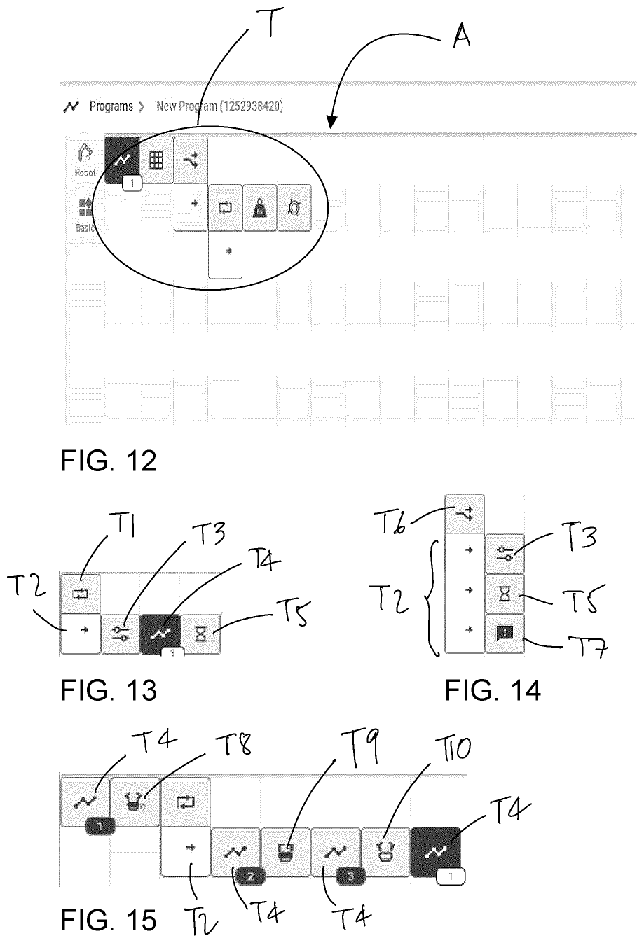

Referring to concurrently to FIGS. 12-15, the programming table A is shown, along with tiles T. The tiles T are jointly referred to as “T”, but may be affixed with a number to distinguish the tiles T from one another in the present description. The programming table A may also be referred to as a grid, an array, a spreadsheet, etc. The programming table A is configured to receive tiles T, according to a timeline, with the programming table A displaying a sequencer or sequencing logic of operation for the robotic arm 10. In an embodiment, the timeline axis extends horizontally from left to right, i.e., a start of a program is to the left-hand side of the table A. Stated differently, the tiles T in a row are in accordance to an execution sequence (though the tiles in a column could be in the execution sequence in a variation of FIG. 12), the execution sequencing indicative of what the order in which the tiles T dictate the operation of the controller of the robotic arm 10. In the vertical direction, a condition axis goes from top to bottom. Different axis orientations are possible though the one shown in FIG. 12 is graphically ergonomic especially for wide screens, enabling for instance a left-to-right scrolling to view the program. Given the tile based system, zooming in/out is possible.

Accordingly, tiles T representative of actions may be positioned in the table A, in order of execution. For example, tiles T may be dragged and dropped, or inserted by text, by a selection in a menu, etc. A first tile T on the left-hand side is indicative of an action or decision occurring before an action or decision presented by a second tile T to the right of the first tile T. In the condition axis, the tiles T are representative of actions or decisions occurring according to conditions. For example, based on measured parameters, system status, outputs, etc, the execution module 130 may select to perform any given one of the tiles T in the column.

For example, referring to FIG. 13, a series of tiles T illustrative of actions to be performed by the robotic arm 10 are shown, as input in the programming table A. The first action would be via tile T1, as it is the left-side most and upper-most tile in the series of tiles T shown. Tile T1 is a loop tile. The loop tile T1 will result in a repeat of a sequence of actions to take place. The sequence is introduced by sequence tile T2. As an example, the sequence of actions that will occur are a setting action (tile T3), three waypoints (tile T4), and a pause (tile T5). The setting action tile T3 allows the program to set variables, that may then be used in the subsequent steps. For example, tile T3 may be used to set a speed of rotation or of displacement and may be programmed optionally with the various buttons on working end 10A. The waypoint tiles T4 require the robot arm 10 to reach given waypoints. In a variant, the various waypoints may be recorded using the admittance mode, with the user placing the working end 10A/end effector at selected positions, and recoding same, using for example the waypoint button 14B (FIG. 4). An indicia bubble may be present to show the number of waypoints that are programmed, as seen with the number “3” in FIG. 1. The pause tile T5 may cause a timed pause of movements for the robotic arm 10, the amount of time being programmed or calculated. This sequence is merely an example among any number of sequences. Loops allow for a sequence of tiles to be replayed multiple times. The sequence of tiles can be played a fixed number of times in a first variant. In a second variant, the execution module 130 can keep track of how many times the sequence of actions/tiles runs using an incrementor or like counting module. As another variant, the execution module 130 can run the sequence of actions/tiles as long as configurable conditions are met. Once the appropriate number of sequence(s) has been run, the execution module 130 may resume operations according to a tile in the same row as that of the loop tile T1.

As another example, referring FIG. 14, a series of tiles T illustrative of actions to be performed by the robotic arm 10 are shown, as input in the programming table A the first action would be via tile T6, as it is the left-side most and upper-most tile in the series of tiles T shown. Tile T6 is a condition tile, i.e., an “if, else” tile. Conditions are then introduced via the sequence tiles T2, with four choices (via three branches, and the option of not executing any branch of the conditions of the three branches are not met) being possible for the condition tile T6. One of the choices is a setting action, via tile T3. Another choice is a pause via pause tile T5. Another choice is the message tile T7. Thus, the condition tile T6 allows the execution module 120 to only execute a set of tiles (once) if certain configurable conditions are met. Multiple conditions can be verified by the same tile such that the robotic arm 10 may choose a branch to execute based on the status of the program. As an example, one can image a scenario where a robotic arm has to wait for a part to be seen before moving and grabbing it. A condition could be used with a “seen” variable.

As yet another example, the programming table A is used with tiles specific to the end effector, shown in the tiles as being a gripping mechanism (a.k.a., gripper) that may open and close. With the gripper at a given waypoint, the gripper may be initiated to perform subsequent movements, as per tile T8. According to the sequence, once reset, loops are to be performed as introduced by loop tile T1. The illustrated loop includes teaching two waypoints, to then close the gripper as per tile T9. The waypoints may represent a path to be taken by the gripper, e.g., move over an object, to then descend toward the object for subsequent grasping. Three waypoints may be reached, after which the gripper is opened as per tile T10. The robotic arm 10 may then be required to move to a given waypoint to complete the loop. The gripper tiles T8, T9 may possibly be hardware-agnostic (e.g., not specific to a certain gripper geometry or gripper manufacturer) thus leading to the re-use of the program no matter the nature of the end effector tooling.

Thus, FIGS. 13, 14 and 15 give three examples of sequences of actions and decisions that may be programmed using the programming table A of the teaching module 120. The programming table A allows a user to see in one screen the possible branches associated with conditions. The branches may be located in adjacent rows in the programming table A, in a same column. Accordingly, a logic of operation of the robotic arm 10 can be programmed and interpreted with more ease than in scenarios where scrolling and/or page switching are necessary to see the various possible branches. Alternatively, other programming interfaces may be used, instead of the programming table A. In addition, a conversion can be available to convert the programming sequence/table A into a text-based programming language, or vice-versa. The programming table A nevertheless enables a rapid programming of actions to be taken by the robotic arm 10, with numerous other tiles also being available, with associate parameter zones B being accessible to enter parameters associated with some of the tiles T.

The teaching module 120 may operate a plurality of teaching modes, according to which the execution module 130 of the robot control system 100 will learn about different maneuvers or tasks to be performed by the robotic arm 10. In an embodiment, a user may alternate between different modes, using the interface 14 (FIG. 4). For example, the mode toggling button 14C may be used, to alternate between the different modes. The light display 12D, and/or a monitor or screen from the user interfaces 102D may show the selected mode, and may be used for an operator to enter additional information.

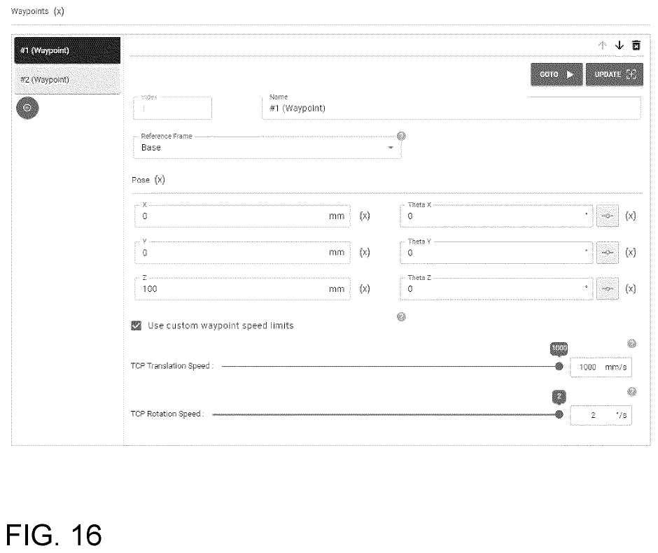

The modes may for example be used in the context of the recording of waypoints, as per waypoint tiles T4. In a first mode of the teaching module 120, a current robot position and orientation of the working end 10A may be recorded while a user hand guides movement of the working end 10A of the robotic arm 10. This recording of robot position may be for the position of a part of an end effector at the working end 10A. For instance, the tool center point (TCP) of the tool at the working end 10A may be used as reference for waypoint recording. The waypoint button 14B may be used to record the position and orientation. The arrangement of the wrist 12 is such that one hand of the user may hold the wrist 12 with the enabling button 14A being depressed, while the other hand may be used to press the waypoint button 14B. In the first mode, referred to as Cartesian value waypoint recording mode, with reference to FIG. 16, different waypoints, shown as #1 and #2 (fewer or more may be recorded) may be recorded. The current robot position is expressed in Cartesian values, i.e., coordinates in a X-Y-Z coordinate system, for instance fixed relative to the base link 20′, or other reference frame. If an object is to be picked up from a surface that is fixed relative to the base link 20′, the use of the X-Y-Z coordinate system of the base link 20′ may facilitate the entry of coordinates. Likewise, the orientation of the tool at the waypoint may also be recorded, with angles relative to the X-Y-Z coordinate system. The user may also set a translational speed and/or a rotation speed, as observed from the GUI of FIG. 16. For example, the level button 14D may be used for such adjustments. In the GUI of FIG. 16, the (x) icon may be used to select a pose variable for the entire pose or a number for a single element. The “Go To” tab in the GUI of FIG. 16 may be used to move the robotic arm 10 to the selected waypoint, while the “Update” tab can be used to change the pose of the selected waypoint to the current physical pose of the robotic arm 10. These tabs are optional. In an embodiment, due to the positioning of the interface 14 on the wrist 12, it is possible for a user to hand guide the robotic arm 10 and record the position of the robotic arm 10 with a single hand.

As an example, the end effector may be required to perform a straight line movement between two waypoints. An example may be a welding gun used as an end effector. As another example, a drilling tool may be used as an end effector. The end effector may be required to move from waypoint A to waypoint B to perform a given maneuver. For example, waypoints A and B may be then end points of a weld line, in the case of a tip of a welding gun. As another example, waypoints A and B may be representative of a drill path and depth. The first mode may be used to record the coordinates of the waypoints A and B in the coordinate system, for subsequently performing these tasks.

As another example, the end effector may be required to be in a given orientation when performing a task. In the example of the welding gun used as an end effector, the tip of the welding gun may be at a given angle to perform the weld. In the example of the drilling tool used as an end effector, the recorded orientation may have a drill bit collinear with a drilling path or offset in position or in orientation in relation to such a path.

In order to assist in determining a path of movement between waypoints A and B, the user may hand guide the end effector at the working end 10A to the waypoints A and/or B. The user may also use the interface 14, for instance to control the movement of the end effector at the working end 10A. For example, the enabling button 14A or equivalent may be used to control the movement of the robotic arm 10, in free hand movement. The jog mode may thus be useful for such movements, in that manipulations would not be required. The recording of a plurality of waypoints in the first mode may be part of a trajectory recording. For example, by holding a button, e.g., the capture button 14B, the first mode may enable a continuous or semi-continuous trajectory capture (e.g., spline interpolation or like registration event).

The recorded waypoints may be ranges of positions that may be deemed acceptable in a workflow. For example, in pick and place tasks with a gripper, the gripper may deposit an item in a zone, as opposed to depositing it in a given position.

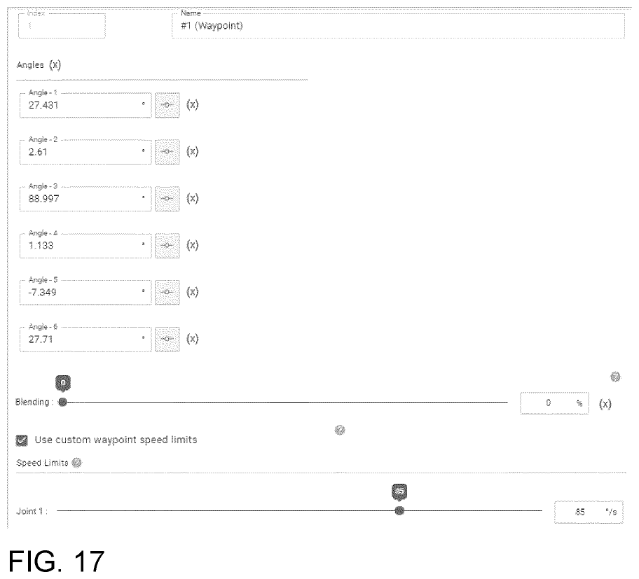

Another mode, referred to arbitrarily as a second mode or angular value waypoint recording mode, may also be used in the context of recording of waypoints, as per waypoint tile T4. The second mode has the waypoint recorded as angular values of the various motorized joints 30 between adjacent links 20, as illustrated in FIG. 17. Thus, in this second mode, the position and orientation of the robotic arm 10 may be recorded via the joint angles, pursuant to a user hand adjusting joint angles for the links 20 of the robotic arm 10. Again, the waypoint button 14B may be used, but to record the orientations. In the second mode, the current robot orientation is expressed in angles of the joints, with six values shown in FIG. 17, for the six joints of the robotic arm 10 (fewer or more may be present). In similar fashion to the first mode, in the second mode the positioning of the interface 14 on the wrist 12 may allow a user to hand guide the robotic arm 10 and record the orientation of the robotic arm 10 with a single hand. In the waypoint recording, in an embodiment, the user may automatically record a specific spline-interpolation and registering mode when holding the waypoint capture button 14B for a defined time.

In FIG. 17, the screen may also have a blending scale. The controller system 100 may usually perform a time-optimal blending. However, the user may define a blending percentage, defining how close to a current waypoint each actuator starts moving towards the next (0%=no blending), in order to minimize acceleration/jerk and optimize cycle time. The user could alternatively define a blending radius, in the case of Cartesian waypoints, such that the radius defines the path that will “shortcut” and avoid the waypoint. Customized joint speed limits can be defined for each joint for individual waypoints. For example, the level button 14D may be used for such adjustments.

In a third mode, a level or intensity of actions associated with the end effector may be recorded of the teaching module 120. As another example, the end effector is a gripper, for instance used in a pick and place operation. The third mode may be selected by the user for the levels of grasping force of the gripper to be recorded.

In another embodiment, the end effector can perform vacuuming. The third mode may be used to indicate when the end effector is to perform suction or release suction.

In a fourth mode, a force applied by the end effector at the working end 10A may be recorded. In a variant, the robotic arm 10 adopts a lock mode, and the user may exert a given pressure on the end effector. Force sensor(s) in the end effector and/or wrist 12 may measure the force, and record it. The robotic arm 10 could then reproduce the force vector during a task. As another possibility, the user may use the enabling button 14A to have the robotic arm 10 effect a movement in a direction, and manually oppose a force to the end effector. The force vector or impedance may be measured. The level button 14C could also be used in the process. The force applied and recorded may be indicative of a minimum and a maximum force.

In parallel to the capture of data using any one of the modes mentioned above, a graphic-user interface of one of the user interfaces 102D may display the information as it is recorded. The user interface 102D may be used as a teach pendant. In order to assist the user in toggling through steps, color and/or light signaling may be used during a teaching sequence. For example, the display light 12D may be green to allow recordation in a selected mode. The display light 12D may flash or change colors when toggling between modes. A color (e.g., red) may be indicative of problems that must be resolved.

In any of the modes, the hand guiding may be facilitated by the locking of any combination of DOFs of the robotic arm 10. For example, the robotic arm 10 may be instructed to move only in a single DOF of the robotic arm 10, such as along a linear path, or to rotate about a single axis. Other examples include the end effector constrained to moving along a work plane, sliding along the side or the edge of a jig, being axially in line for example with a screwdriver or other similar tool, or moving spherically around a remote center of motion, such as moving around an object centered in jaws of a gripper mechanism.

Accordingly, the various modes described herein may record positions, orientations, levels, forces, and/or impedance associated with the robotic arm 10, for instance as tied to a specific end effector. The execution module 130 may therefore populate given task workflows with the taught information, to perform tasks and maneuvers, as taught by the teaching module 120.

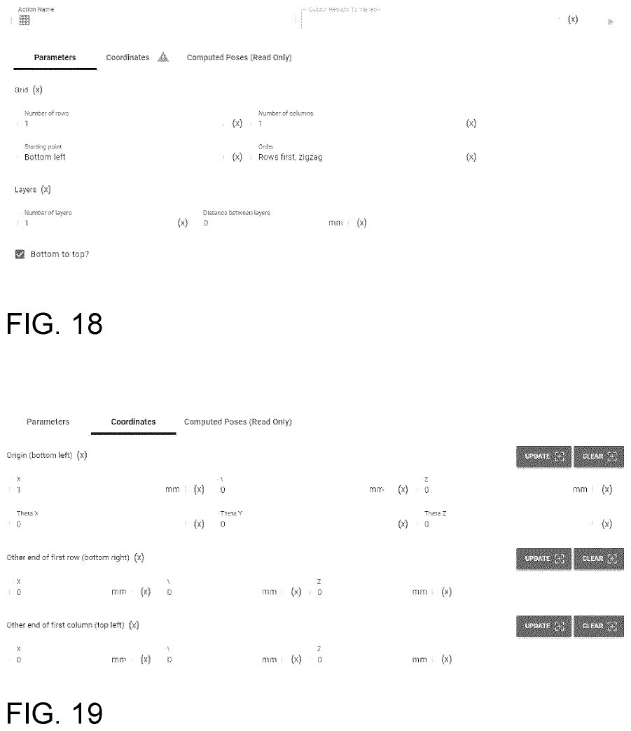

Referring to FIGS. 18 and 19, screens associated with a matrix function (having a related tile) are shown. The role of the matrix function and associated tile is to generate a list of Cartesian poses following a grid pattern, then to output it to a matrix output object variable for reuse. The grid may be defined per number of rows and columns as in FIG. 18, and by order values, e.g., “bottom left” as an exemplary starting point, and with an order defied as “rows first, zigzag”, as an example. According to FIG. 19, a user may elect the coordinates of the corners of the grid as indicated so that the execution module 120 can automatically distribute the rows and columns evenly. An “Update” tab may optionally be provided to fill in the coordinates of the corners using the robot's current pose. The screens in FIGS. 18 and 19 are shown as being associated with a given tile. However, it is possible to integrate the screens in FIGS. 18 and 19, or information found in these screens, into screens associated with other tiles, such as in a variable manager tile.

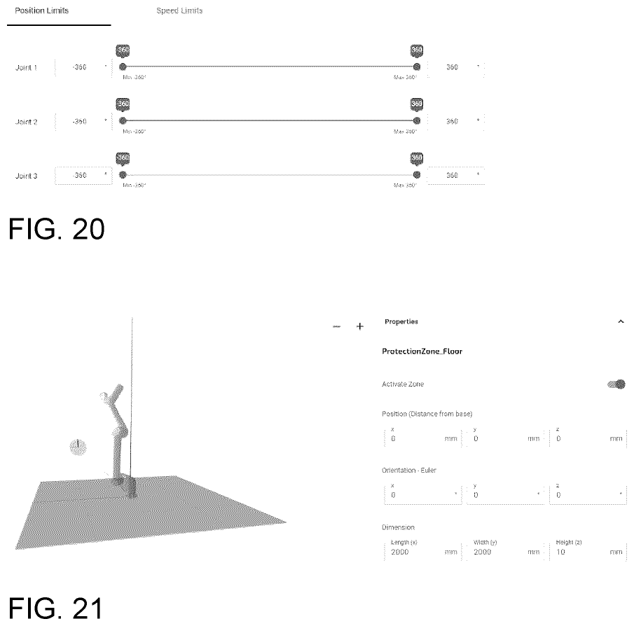

Referring to FIGS. 20 and 21, GUI screens showing safety functions are shown. The GUI screens enable a user to set position limits for the various joints and/or speed limits (FIG. 20). The level button 14D may be used for the user to readily set the limits. In FIG. 21, the parameters of a protection zone may be entered, relative to a frame of reference. The protection zone is a volume in the workspace of the robotic arm 10 which the robotic arm 10 is prevented from entering. If any part of the robotic arm 10 is about to enter a protection zone, the execution module 130 may force a stop of the robotic arm 10. As an example, a protection zone called Tool Sphere is attached to the working end 10A of the robotic arm 10 to define a protected volume around the tool at the working end 10A, this functionality being provided for a user to configure a protected volume to a given end effector, the protected volume being customizable as a function of the end effector. For example, while a sphere is described, other shapes are considered, such as a box. Additional static protection zones can be added to the workspace with the screen of FIG. 21. Numerous protection zones can be active concurrently.

The system for teaching a robotic arm may therefore include some or all of the components described herein. For example, as part of the system for teaching a robotic arm 10, there may be included the interface 14, the processing unit like the CPU 102A; the non-transitory computer-readable memory 102C, any of the interfaces 102D, the teaching module 120, the execution module 130.

The system may alternatively or additionally be described as including a processing unit like the CPU 102A; and a non-transitory computer-readable memory 102C communicatively coupled to the processing unit and comprising computer-readable program instructions executable by the processing unit for: recording a position of the working end of the robotic arm in response to signaling from the user interface in a first mode; recording an orientation of the working end of the robotic arm in response to signaling from the user interface in a second mode; recording a force applied at the working end of the robotic arm in response to signaling from the user interface in a third mode; and toggling between the first mode, the second mode and the third mode in response to signaling from the user interface.

The programming table A of FIG. 12 may be described as being a compact program timeline design, with tiles T on a program timeline being used, where tiles T represent a program action, parameterization or decision. In a variant, program actions are executed from left to right as depicted on the program timeline in FIG. 12. The multi-row design may be used to highlight decision that the program can take (e.g., conditions, loop). In a variant, collapsible/expandable tiles may allow a quick overview of entire program or the ability to see program details. The programming table A is an agnostic visual programming design that may allow a user to visualize any type of actions in a consistent fashion. In an embodiment, it may be possible to export/import/convert between visual programming and a native (XML, JSON, etc.) or general language (e.g., Python).

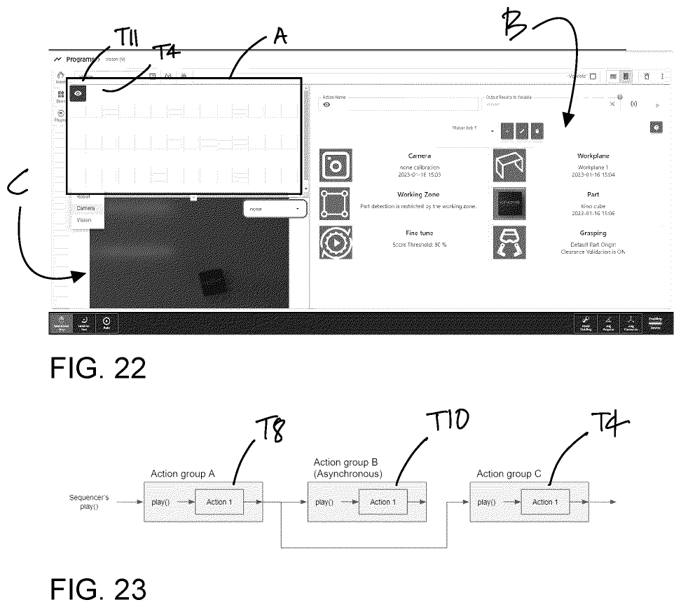

An agnostic camera hand-eye vision system may be used, with a vision module being one of the peripherals 50 (FIG. 5). In parallel, the GUI screen shown in FIG. 22 may be used as one possible option. The screen in FIG. 2 has the programming table A, including vision tile T11, as well as a live video feed from the vision system, such as in viewing zone C. The screen may also have the parameter zone B used for the set up and operation of the vision features. For example, one or more of the options may be available, as examples among others: Camera Selection, Workplane, Working Zone, Part Model Creation, Model Parameters Tuning, Part Grasping and Clearance Validation. The Camera Selection option may be used to enter in any appropriate way an identity of the camera that will be mounted to the working end 10A of the robotic arm 10. The Workplane option may be used to calibrate a work plane reference frame in which the robotic arm 10 will act. For example, the Workplane is calibrated by putting a calibration object(s) whose geometry is known, for the vision system to observe same and calibrate the Workplane using the known geometry. The Working Zone option enables to delimit or define the boundaries of the area covered by the vision system. The Part option allows to set an image of the sought image. The Fine Tune option is used to define feature recognition thresholds. As for the Part Grasping option, it may be used to define the preferential grasping angle on the part. The Grasping option may thus be used to program the robotic arm 10 in grasping an object as observed in the video feed. Accordingly, vision tile T11 may be a vision plug-in tile permitting any GiGE camera to be calibrated/adjusted and used by any plug-in or program for vision based decision making, tracking, calibration or reference frame definition, and/or capable of working with any 2D generic GiGE vision cameras. The vision system offers robot vision guidance capabilities to enable unstructured object manipulation tasks using for example a wrist-mounted or stationary/external 2D/3D camera, such as a GigE vision camera. For example, detection of the workpieces on the working surface followed by a pick and place operation may be performed by the robotic arm 10 equipped with a vision system. By using point and click operations provided within the execution module 130, (e.g., via a vision plugin application), the end user can calibrate working surface and teach workpiece models, for instance based on shape features or color/intensity blob parameters. Additionally, in order to facilitate proper object approach and grasping, a gripper clearance configuration and validation capability may also be provided.

Once the vision task is configured, the vision system can perform workpiece matching operations and determine 3D poses of the located workpieces with respect to the frame of reference of the robotic arm 10. The detection results and workpiece locations are communicated in a similar fashion. The visual programming environment can then treat the detected poses as custom frames and apply a previously taught object manipulation routine. The object manipulation routine may include, for example, pre-approach, approach, grasping and retreat poses in the task of object picking. The detection and localization functionality can also be extended to support specifically crafted fiducials/landmarks and/or to create additional custom reference frames based on these. The fiducials, landmarks and/or reference frames may then be used to locate trays containing multiple workpieces or dynamically adjust affected Cartesian waypoints and adapt the robotic arm 10 to work in a flexible unstructured environment. Also, among other common uses enabled by the vision system are presence/absence detection, OCR, bar-code reading, etc.

The programming table A may have a non-blocking feature by which some actions may occur concurrently. This is shown in FIG. 23, with respect to action groups A, B and C. For example, action group A may be equivalent to tile T8 for gripper reset, action group B may be a tile T10 for opening a gripper, and action group C may be a waypoint tile T4, by which the robotic arm 10 moves along a given path. This is just an example among many others of action groups that may be said to be non-blocking, or asynchronous. According to this non-blocking feature, action groups B and C may occur concurrently, instead of being sequential. Therefore, in this example of FIG. 23, the gripper may open while moving along the waypoint path. If this example is applied to the sequence of actions of FIG. 15, the reset tile T8, the closing tile T9, and the opening tile T10 may all selectively be asynchronously paired with the waypoint tiles T4 preceding them in the programming table A, meaning that the robotic arm 10 operates the gripper while moving. Accordingly, there results an efficiency in operation from this non-blocking feature. The non-blocking feature may generally be applied to tiles that do not include branching (ex: non-branching: open/close, set variables, etc; blocking/branching not allowed to be asynchronous, such as conditions or loops).

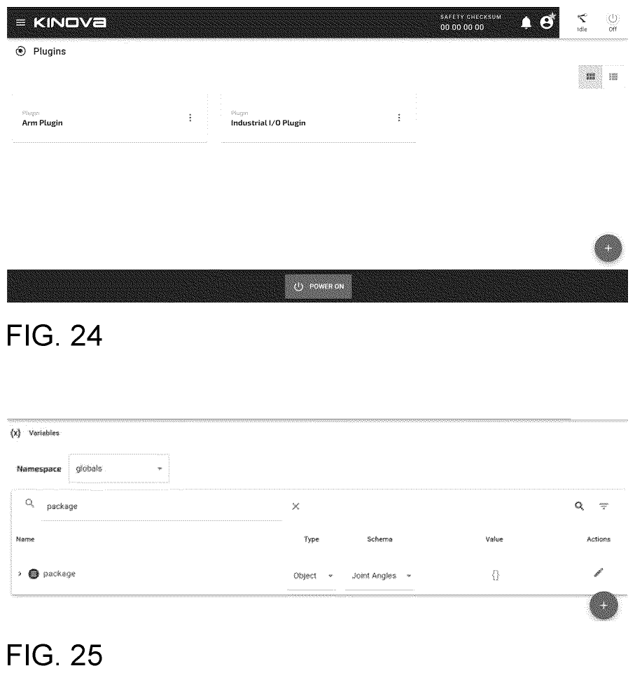

Referring to FIG. 24, there is illustrated an example of a plugin screen, by which a user can identify the plugin tool that is currently used, whether at the working end 10A of the robotic arm 10, such as end effector, or at other locations. Once the selection of plugin tool is made, the parameters of the operation of the plugin tool may be entered or adjusted, according to the properties of the tool.

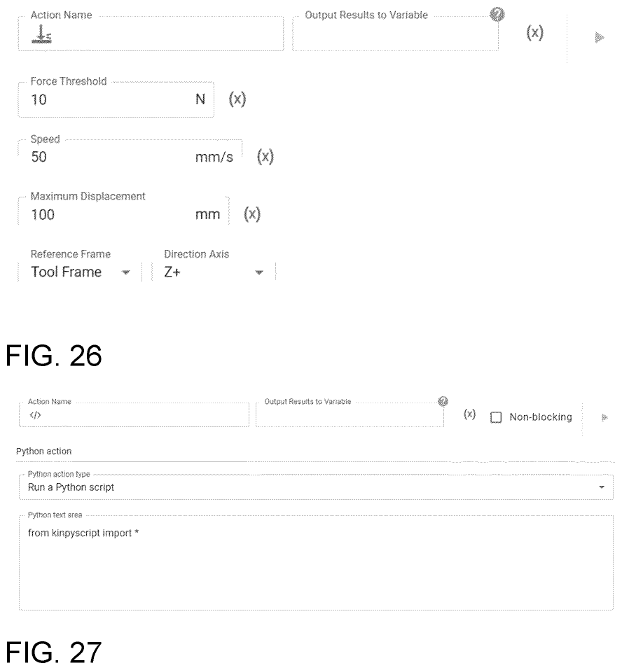

FIG. 25 is a screen view showing an example of a seek function screen. The seek function may be associated with the search of an object, which search may be conducted by tactile detection. For example, the end effector may be a gripper, and the combination of the gripper and robotic arm 10 may move within a given working zone in the search for objects. Contact with the object may be sensed by the various sensors in the gripper and/or robotic arm 10. A tile may be associated with such seek function, as exemplified for instance by the logo shown in the field Action Name. Upon detection of an object, the variables associated with the location may be transferred (output results) to screens such as in FIG. 26.

To define the Seek action, contact parameters must be quantified. Examples of parameters include Force Threshold, Speed of Displacement and Maximum Displacement. The frame of reference may be selected (e.g., tool or base), and the direction of movement as well, as a function of the frame of movement.

FIG. 27 is a screen view showing an example of a script entering screen. A tile may be associated with a script entering screen, and the script may be executed once or if the workflow of the programming table A reaches the tile associated with the script. In a variant, the script is in Python® or in any other format, i.e., programming languages that enable the execution of various functions for the robotic arm 10. While the programming may be performed on site when teaching the robotic arm 10, user may import scripts that have been coded beforehand. Hence, for more complex maneuvers associated with various end effectors or like implements, the robot control system 100 may rely on the script to perform such actions, instead of relying on a sequence of tiles. This may for example resolves issues of availability of robotic arms 10, and even though the programming described herein is ergonomic, efficient and simplified, it may be desired in some instances to use scripts programmed away from the robotic arm 10.

The programming interface of the robotic arm 10, as operated for example by the control system 100 (i.e., controller) may be described as having a programming table including rows and columns of cells, wherein the cells in the rows or in the columns represent an execution sequence; tiles (icon, tab, etc.) positionable in the cells, each of the tiles representing at least one of an action, a decision, a condition associated with the robotic arm; wherein, during operation of the robotic arm, a controller operates the robotic arm based on the execution sequence and on the tiles in the programming table.

In a variant, the cells in the rows represent the execution sequence. The cells in a common one of the columns may represent a condition sequence. Tiles in the cells in the common one of the columns may form the condition sequence are each adjacent to another tile in a respective one of the rows, the other one of the tiles indicating an action and/or a decision of the condition sequence, i.e., some of the conditions may include an execution sequence by extending into the execution sequence direction. At least one some of the tiles may have another part of a GUI of a programming interface showing one or more of the parameters related to the condition, action, decision. One of the tiles may be a waypoint tile identifying at least one waypoint position and/or orientation to which the controller directs the robotic arm. The waypoint tile may further includes one or more parameter setting associated with a movement of the robotic arm to the waypoint position and/or orientation. The waypoint position and/or orientation of the waypoint tile is set from a signal received from a wrist of the robotic arm. One of the tiles may be a script tile, according to which the controller operates the robotic arm as a function of the script. The script may be Python®. One of the tiles may be associated with an actuation of an end effector of the robotic arm. The end effector may be a gripper. The tile associated with the actuation is to cause an opening of the gripper and/or a closing of the gripper. The tile associated with the actuation may also have one or more parameter settings associated with the actuation of the gripper, such as a parameter setting associated with the actuation of the gripper is a closing force or a closing speed. The tile associated with the actuation is to cause the end effector to seek the presence of an object by contact. The tile associated with the actuation may further include at least one parameter setting associated with the seek of the object, wherein the at least one parameter setting associated with the seek is one or more of a limit of contact force, a limit of displacement speed, a constraint in trajectory of movement. One of the tiles may be associated with an operation of a vision system of the robotic arm. The operation of the vision system may include providing a video feed on the programming interface.

The present disclosure pertains to a system for teaching a robotic arm that may have a user interface at a working end of a robotic arm; a processing unit; and a non-transitory computer-readable memory communicatively coupled to the processing unit and comprising computer-readable program instructions executable by the processing unit for: recording a position of the working end of the robotic arm in response to signaling from the user interface in a first mode; recording an orientation of the working end of the robotic arm in response to signaling from the user interface in a second mode; and toggling between at least the first mode and the second mode in response to signaling from the user interface. Optionally, in the first mode, the robotic arm moves in Cartesian admittance as a response to a force applied to the working end, the working end having a constant orientation in the Cartesian admittance.

Optionally, in the second mode, the robotic arm moves in angular admittance as a response to a force applied to the working end, the robotic arm constraining movement to a rotation of a single joint in the angular admittance. The system may record a force applied at the working end of the robotic arm in response to signaling from the user interface in a third mode.

The controller system 100 may be described as a system for programming a robotic arm and robot cell, with horizontal timeline featuring expandable/collapsible subroutines which can be re-used and which enable either a quick overview of the complete program or ability to zoom/focus on specific elements, that may be tuned. A programming table A may be programmed with tiles associated with native robot functions, or with functions associated with OEM or 3rd party plug-ins. The plug-ins may be hardware-agnostic plug-in system for end effectors and vision systems/cameras with blocks capable of being re-used and permitting visualizing of any type of action in a consistent fashion.

Among tiles T not shown, there may be: a grasping plug-in tile permitting any two or three finger gripper or single-acting vacuum gripper to be used in the same fashion (close/open, suction no suction, force/speed adjustment if accessible); Pick, Place, Stack, Matrix, Screw, Insert, Follow, Find tiles may also be available. A method is associated with the controller system 100 to seamlessly convert the visual program to and from a text-based script format. Another method may be associated with the controller system 100 to define sub-programs to be re-usable and accessible for higher level programs. The teaching module 120 may include a variable manager may be provided to program the system with advanced, intelligent data types (points, orientations, camera data, strings, etc) in private and global scopes. The variable manager capable of tracking multiple objects in a real-time database (e.g.,: objects on conveyor or in matrix).

1. A programming interface of a robotic arm comprising:
a programming table including rows and columns of cells, wherein the cells in the rows or in the columns represent an execution sequence;
tiles positionable in the cells, each of the tiles representing at least one of an action, a decision, a condition associated with the robotic arm;
wherein, during operation of the robotic arm, a controller operates the robotic arm based on the execution sequence and on the tiles in the programming table.

2. The programming interface according to claim 1, wherein the cells in the rows represent the execution sequence.

3. The programming interface according to claim 2, wherein the cells in a common one of the columns represent a condition sequence.

4. The programming interface according to claim 3, wherein tiles in the cells in the common one of the columns forming the condition sequence are each adjacent to another tile in a respective one of the rows, the other one of the tiles indicating an action and/or a decision of the condition sequence.

5. The programming interface according to claim 1, wherein at least one of the tiles is a waypoint tile identifying at least one waypoint position and/or orientation to which the controller directs the robotic arm.

6. The programming interface according to claim 5, wherein the waypoint tile further includes at least one parameter setting associated with a movement of the robotic arm to the waypoint position and/or orientation.

7. The programming interface according to claim 5, wherein the at least one waypoint position and/or orientation of the waypoint tile is set from a signal received from a wrist of the robotic arm.

8. The programming interface according to claim 1, wherein at least one of the tiles is a script tile, according to which the controller operates the robotic arm as a function of the script.

9. The programming interface according to claim 8, wherein the script is Python®.

10. The programming interface according to claim 8, wherein the script is imported into a field of the programming interface.

11. The programming interface according to claim 1, wherein at least one of the tiles is associated with an actuation of an end effector of the robotic arm.

12. The programming interface according to claim 11, wherein the end effector is a gripper.

13. The programming interface according to claim 12, wherein the at least one tile associated with the actuation is to cause an opening of the gripper.

14. The programming interface according to claim 12, wherein the at least one tile associated with the actuation is to cause a closing of the gripper.

15. The programming interface according to claim 14, wherein the at least one tile associated with the actuation further includes at least one parameter setting associated with the actuation of the gripper.

16. The programming interface according to claim 15, wherein the at least one parameter setting associated with the actuation of the gripper is a closing force or a closing speed.

17. The programming interface according to claim 12, wherein the at least one tile associated with the actuation is to cause the end effector to seek the presence of an object by contact.

18. The programming interface according to claim 17, wherein the at least one tile associated with the actuation further includes at least one parameter setting associated with the seek of the object, wherein the at least one parameter setting associated with the seek is one or more of a limit of contact force, a limit of displacement speed, a constraint in trajectory of movement.

19. The programming interface according to claim 1, wherein at least one of the tiles is associated with an operation of a vision system of the robotic arm.

20. (canceled)

21. A system for teaching a robotic arm comprising:
a user interface at a working end of a robotic arm;
a processing unit; and
a non-transitory computer-readable memory communicatively coupled to the processing unit and comprising computer-readable program instructions executable by the processing unit for:
recording a position of the working end of the robotic arm in response to signaling from the user interface in a first mode;
recording an orientation of the working end of the robotic arm in response to signaling from the user interface in a second mode; and
toggling between at least the first mode and the second mode in response to signaling from the user interface.

22.-24. (canceled)
